(19) United States
(12) Patent Application Publication
(10) Pub. No.: US 2019/0357174 A1
(43) Pub. Date: Nov. 21, 2019

(54) DATA TRANSMISSION METHOD, APPARATUS AND SYSTEM

(71) Applicant: CHINA ACADEMY OF TELECOMMUNICATIONS TECHNOLOGY, Beijing (CN)

(72) Inventors: Zheng ZHAO, Beijing (CN); Ekpenyong TONY, Beijing (CN); Bin REN, Beijing (CN); Xueming PAN, Beijing (CN)

(73) Assignee: China Academy of Telecommunications Technology, Beijing (CN)

(21) Appl. No.: 16/476,074

(22) PCT Filed: Jul. 2, 2018
(86) PCT No.: PCT/CN2018/075649

§ 371 Date: Jul. 3, 2019

(30) Foreign Application Priority Data
Jan. 6, 2017 (CN) 201710011308.X

(51) Int. Cl. H04W 72/00; H04W 72/04; H04W 74/00

(52) U.S. Cl. CPC H04W 72/005; H04W 74/004; H04W 72/0453; H04W 72/0446

(57) ABSTRACT

A data transmission method, apparatus and system, the method comprising: for an initial access uplink data transmission, determining a modulation and coding scheme for uplink data according to protocol specification and/or base station broadcast information; using the determined modulation and coding scheme to perform modulation and coding on the uplink data, and sending a preamble and the modulated and coded uplink data. In the present invention, the modulation and coding scheme for the uplink data for the initial access uplink data transmission is determined according to the protocol specification and/or base station broadcast information, and the modulation and coding is thereby performed on the uplink data.

This application claims the benefit of Chinese Patent Application No. 201710011308.X, filed with the Chinese Patent Office on Jan. 6, 2017, and entitled “Data transmission method, device, and system”, which is hereby incorporated by reference in its entirety.

### FIELD

The present invention relates to the field of communications, and particularly to a data transmission method, device, and system.

### BACKGROUND

As the wireless communication technologies are advancing rapidly, User Equipments (UEs) have stepped into our life, and as the UEs are being popularized, the UEs have become an electronic product indispensable to our life. At present, the UEs have been provided with abundant functions, and we can play a game, watch a video, grab lucky money, fight for a flash sale, etc. on the mobile terminals with a great pleasure. As the UEs are being popularized and widely applied, there is a demand for more powerful UEs, and particularly UEs with a shorter delay in data transmission between a UE and a next-generation Node B (gNB).

In the existing Long Term Evolution (LTE) system, there is a four-step mechanism for a random access of a UE, and as illustrated in FIG. 1, the four-step mechanism includes an msg1 random access preamble, an msg2 random access preamble, msg3 scheduled transmission, and msg4 contention resolution. Uplink multi-beam Packet Random Access Channel (PRACH) transmission in a next-generation radio (NR) 5G system suffers from such a control-plane long delay that the performance index of a short delay defined for an Ultra Reliable and Low Latency Communication (URLLC) scenario cannot be satisfied.

At present, in order to shorten a delay, the msg1 preamble is transmitted together with data as discussed in the standard, and as illustrated in FIG. 2, a procedure of a random access in a two-step mechanism includes an msg1 random access preamble plus data, and an msg2 random access preamble, and Msg3 and Msg4 are omitted as opposed to the four-step random access mechanism in the LTE system, thus shortening in effect a control-plane delay.

However there has been absent so far a solution to determining by the UE and the gNB a modulation and coding scheme of the data in Msg1.

### SUMMARY

Embodiments of the invention provide a data transmission method, device, and system so as to encode and modulate data in a random access.

An embodiment of the invention discloses a data transmitting method applicable to a UE, the method including:
determining a modulation and coding scheme of uplink data for uplink data transmission of an initial access according to a protocol specification, and/or information broadcasted by a gNB; and
encoding and modulating the uplink data using the determined modulation and coding scheme, and transmitting a preamble, and the encoded and modulated uplink data.

Furthermore the determining the modulation and coding scheme of uplink data for uplink data transmission of an initial access according to the protocol specification, and/or the information broadcasted by the gNB includes:
selecting one of at least one modulation and coding scheme specified in the protocol specification and/or broadcasted by the gNB as the modulation and coding scheme of uplink data.

Furthermore the method further includes:
determining the modulation and coding scheme of uplink data according to a correspondence relationship between resources and modulation and coding schemes specified in the protocol specification and/or broadcasted by the gNB.

Furthermore the resources include at least one of:
preambles, and time and frequency resources for transmitting preambles.

Furthermore when the resources are preambles, the determining the modulation and coding scheme of uplink data includes:
determining a modulation and coding scheme corresponding to the preamble in the uplink data transmission as the modulation and coding scheme of uplink data according to a correspondence relationship between preambles and modulation and coding schemes; or
selecting a modulation and coding scheme in a modulation and coding scheme group corresponding to the preamble in the uplink data transmission as the modulation and coding scheme of uplink data according to the preamble in the uplink data transmission, and a correspondence relationship between preambles and modulation and coding scheme groups, wherein each modulation and coding scheme group includes at least two modulation and coding schemes.

Furthermore when the resources are time and frequency resources for transmitting preambles, the determining the modulation and coding scheme of uplink data includes:
determining a modulation and coding scheme corresponding to a time and frequency resource group including a time and frequency resource for transmitting the preamble in the uplink data transmission as the modulation and coding scheme of uplink data according to the preamble in the uplink data transmission, and a correspondence relationship between time and frequency resource groups and modulation and coding schemes; or
selecting a modulation and coding scheme in a modulation and coding scheme group corresponding to a time and frequency resource group including a time and frequency resource for transmitting the preamble in the uplink data transmission as the modulation and coding scheme of uplink data according to the time and frequency resource for transmitting the preamble, and a correspondence relationship between time and frequency resource groups and modulation and coding scheme groups, wherein each modulation and coding scheme group includes at least two modulation and coding schemes.

Furthermore when the resources are preambles, and time and frequency resources for transmitting the preambles, the determining the modulation and coding scheme of uplink data includes:
determining a modulation and coding scheme corresponding to the preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding schemes; or
selecting a modulation and coding scheme in a modulation and coding scheme group corresponding to the preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding scheme groups, wherein each modulation and coding scheme group includes at least two modulation and coding schemes.

An embodiment of the invention discloses a data receiving method applicable to a gNB, the method including:
receiving encoded and modulated uplink data, and a preamble, transmitted by a UE, and determining a modulation and coding scheme of uplink data according to a protocol specification, and/or information broadcasted by the gNB; and
decoding and demodulating the uplink data using the determined modulation and coding scheme.

Furthermore the determining the modulation and coding scheme of uplink data according to the protocol specification, and/or the information broadcasted by the gNB includes:
selecting one of at least one modulation and coding scheme specified in the protocol specification and/or broadcasted by the gNB as the modulation and coding scheme of uplink data.

Furthermore the method further includes:
determining the modulation and coding scheme of uplink data according to a correspondence relationship between resources and modulation and coding schemes specified in the protocol specification and/or broadcasted by the gNB.

Furthermore the resources includes at least one of:
preambles, and time and frequency resources for transmitting preambles.

Furthermore when the resources are preambles, the determining the modulation and coding scheme of uplink data includes:
determining a modulation and coding scheme corresponding to the preamble in the uplink data transmission as the modulation and coding scheme of uplink data according to a correspondence relationship between preambles and modulation and coding schemes; or
decoding and demodulating the uplink data using each of at least two modulation and coding schemes in a modulation and coding scheme group corresponding to the preamble in the uplink data transmission sequentially according to the preamble in the uplink data transmission, and a correspondence relationship between preambles and modulation and coding scheme groups, and determining a modulation and coding scheme with which the uplink data is decoded and demodulated successfully as the modulation and coding scheme of uplink data.

Furthermore when the resources are time and frequency resources for transmitting preambles, the determining the modulation and coding scheme of uplink data includes:
determining a modulation and coding scheme corresponding to a time and frequency resource group including a time and frequency resource for transmitting the preamble in the uplink data transmission as the modulation and coding scheme of uplink data according to the preamble in the uplink data transmission, and a correspondence relationship between time and frequency resource groups and modulation and coding schemes; or
decoding and demodulating the uplink data using each of at least two modulation and coding schemes in a modulation and coding scheme group corresponding to a time and frequency resource group including a time and frequency resource for transmitting the preamble in the uplink data transmission sequentially according to the time and frequency resource for transmitting the preamble in the uplink data transmission, and a correspondence relationship between time and frequency resource groups and modulation and coding scheme groups, and determining a modulation and coding scheme with which the uplink data is decoded and demodulated successfully as the modulation and coding scheme of uplink data.

Furthermore when the resources are preambles, and time and frequency resources for transmitting the preambles, the determining the modulation and coding scheme of uplink data includes:
determining a modulation and coding scheme corresponding to the preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding schemes; or
decoding and demodulating the uplink data using each of at least two modulation and coding schemes in a modulation and coding scheme group corresponding to the preamble in the uplink data transmission, and a time and frequency resource group including a time and frequency resource for transmitting the preamble sequentially according to the preamble in the uplink data transmission, the time and frequency resource for transmitting the preamble in the uplink data transmission, and a correspondence relationship between preambles and time and frequency resource groups for transmitting the preambles, and modulation and coding scheme groups, and determining a modulation and coding scheme with which the uplink data is decoded and demodulated successfully as the modulation and coding scheme of uplink data.

An embodiment of the invention discloses a data transmitting device applicable to a UE, the device including:
a determining module configured to determine a modulation and coding scheme of uplink data for uplink data transmission of an initial access according to a protocol specification, and/or information broadcasted by a gNB; and
a transmitting module configured to encode and modulate the uplink data using the determined modulation and coding scheme, and to transmit a preamble, and the encoded and modulated uplink data.

An embodiment of the invention discloses a data receiving device applicable to a gNB, the device including:
a receiving an determining module configured to receive encoded and modulated uplink data, and a preamble, transmitted by a UE, and to determine a modulation and coding scheme of uplink data according to a protocol specification, and/or information broadcasted by the gNB; and
a processing module configured to decode and demodulate the uplink data using the determined modulation and coding scheme.

An embodiment of the invention further provides a UE including:
a processor configured to read and execute program in a memory:
to determine a modulation and coding scheme of uplink data for uplink data transmission of an initial access according to a protocol specification, and/or information broadcasted by a gNB, and to encode and modulate the uplink data using the determined modulation and coding scheme; and
a transceiver configured to transmit and receive data under the control of the processor, and configured:
to transmit a preamble, and the encoded and modulated uplink data.

An embodiment of the invention further provides a gNB including:
a transceiver configured to transmit and receive data under the control of a processor, and configured:
to receive encoded and modulated uplink data, and a preamble, transmitted by a UE; and
the processor configured to read and execute program in a memory:
to determine a modulation and coding scheme of uplink data according to a protocol specification, and/or information broadcasted by the gNB, and to decode and demodulate the uplink data using the determined modulation and coding scheme.

An embodiment of the invention further provides a computer device including a memory, a processor, and computer program stored on the memory, and executable on the processor, the processor executing the computer program to perform the data transmitting method above at the UE side.

An embodiment of the invention further provides a computer device including a memory, a processor, and computer program stored on the memory, and executable on the processor, the processor executing the computer program to perform the data receiving method above at the gNB side.

An embodiment of the invention discloses a data transmission system including the data transmitting device above applicable to a UE, and the data receiving device above applicable to a gNB.

In the data transmission method, device, and system according to the embodiments of the invention, a modulation and coding scheme of uplink data is determined for uplink data transmission of an initial access according to a protocol specification, and/or information broadcasted by a gNB; and the uplink data are encoded and modulated using the determined modulation and coding scheme, and a preamble, and the encoded and modulated uplink data are transmitted. In the embodiment of the invention, the modulation and coding scheme for uplink data is determined for uplink data transmission of an initial access according to the protocol specification, and/or the information broadcasted by the gNB so that the uplink data can be encoded and modulated.

### BRIEF DESCRIPTION OF THE DRAWINGS

In order to make the technical solutions according to the embodiments of the invention, or in the prior art more apparent, the drawings to which reference is to be made in the description of the embodiments or in the prior art will be introduced below in brief, and apparently the drawings to be described below illustrate only some embodiments of the invention, and those ordinarily skilled can further derive other drawings from these drawings without any inventive effort.

FIG. 1 is a schematic diagram of a random access in the four-step mechanism;

FIG. 2 is a schematic diagram of a random access in the two-step mechanism;

FIG. 3 is a schematic diagram of a data transmitting process according to a first embodiment of the invention;

FIG. 4 is a schematic diagram of a correspondence relationship between preambles and modulation and coding schemes according to a fourth embodiment and a tenth embodiment of the invention;

FIG. 5 is a schematic diagram of a correspondence relationship between preambles and modulation and coding scheme groups according to the fourth embodiment and the tenth embodiment of the invention;

FIG. 6 is a schematic diagram of a correspondence relationship between time and frequency resource groups and modulation and coding schemes according to a fifth embodiment and an eleventh embodiment of the invention;

FIG. 7 is a schematic diagram of a correspondence relationship between time and frequency resource groups and modulation and coding scheme groups according to the fifth embodiment and the eleventh embodiment of the invention;

FIG. 8 is a schematic diagram of a data receiving process according to a seventh embodiment of the invention;

FIG. 9 is a schematic structural diagram of a data transmitting device according to a thirteenth embodiment of the invention;

FIG. 10 is a schematic structural diagram of a data receiving device according to a fourteenth embodiment of the invention;

FIG. 11 is a schematic structural diagram of a data transmission system according to a fifteenth embodiment of the invention;

FIG. 12 is a schematic structural diagram of a UE according to an embodiment of the invention; and

FIG. 13 is a schematic structural diagram of a gNB according to an embodiment of the invention.

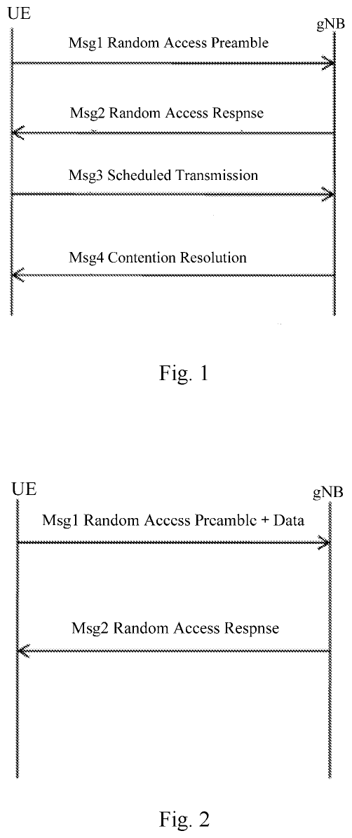

### DETAILED DESCRIPTION OF THE EMBODIMENTS

In order to make the objects, technical solutions, and advantages of the invention more apparent, the invention will be described below in further details with reference to the drawings. Apparently the embodiments to be described are only a part but not all of the embodiments of the invention. Based upon the embodiments here of the invention, all of other embodiments which can occur to those ordinarily skilled in the art without any inventive effort shall come into the scope of the invention as claimed.

For the sake of convenient reading, the embodiments of a part of the technical solutions have been numbered, e.g., the first, second, third, . . . , etc., embodiments, with an emphasis on some independence of the respective technical solutions, but the embodiments have been numbered without suggesting the independence of each embodiment, and in fact, those skilled in art can ascertain their correlation with each other according to their purposes, and decide whether to combine them for their purposes.

### First Embodiment

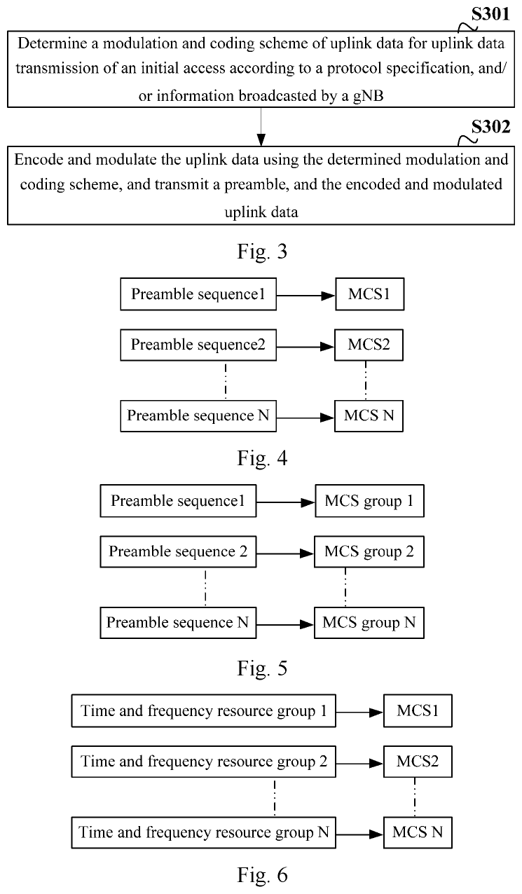

FIG. 3 is a schematic diagram of a data transmitting process according to the first embodiment of the invention, where the process includes the following operations.

The operation 301 is to determine a modulation and coding scheme of uplink data for uplink data transmission of an initial access according to a protocol specification, and/or information broadcasted by a gNB.

In embodiments of the invention, the modulation and coding scheme can be specified in the protocol, or can be broadcasted by the gNB, or can be specified in the protocol, and broadcasted by the gNB.

One or more modulation and coding schemes can be specified in the protocol, and if only one modulation and coding scheme is specified in the protocol for uplink data of an initial access, then the UE will determine the modulation and coding scheme as the modulation and coding scheme of uplink data; and if more than one modulation and coding scheme is specified in the protocol, then the UE may select randomly one of the specified modulation and coding schemes, and determine the selected modulation and coding scheme as the modulation and coding scheme of uplink data.

The gNB can broadcast one or more modulation and coding schemes, and for uplink data of an initial access, if the gNB broadcasts only one modulation and coding scheme, then the UE will determine the modulation and coding scheme as the modulation and coding scheme of uplink data; and if the gNB broadcasts more than one modulation and coding scheme, then the UE may select randomly one of the broadcasted modulation and coding schemes, and determine the selected modulation and coding scheme as the modulation and coding scheme of uplink data.

If the modulation and coding scheme or schemes is or are specified in the protocol, and broadcasted by the gNB, then one of modulation and coding schemes in an intersection set of the modulation and coding schemes specified in the protocol, and broadcasted by the gNB will be selected and determined as the modulation and coding scheme of uplink data.

The operation 302 is to encode and modulate the uplink data using the determined modulation and coding scheme, and to transmit a preamble, and the encoded and modulated uplink data.

The data transmitting method according to the embodiment of the invention is applicable to the UE, and the modulation and coding scheme or schemes of uplink data to be used by the UE and the gNB for uplink data transmission of an initial access is or are pre-specified in the data transmission protocol, or the gNB broadcasts and indicates the modulation and coding scheme or schemes of uplink data for uplink data transmission of an initial access.

FIG. 2 is a schematic diagram of a data transmitting process according to an embodiment of the invention, and in order to shorten a delay in data transmission, a procedure of a random access of a UE to a gNB in a two-step mechanism includes an Msg1 random access preamble plus uplink data, and an Msg2 random access response, where Msg1 includes the preamble and the uplink data.

Particularly for uplink data transmission of an initial access, i.e., Msg1, a modulation and coding scheme of uplink data is determined according to a modulation and coding scheme of uplink data specified in a protocol, and/or carried in information broadcasted by the gNB; and the uplink data are encoded and modulated using the determined modulation and coding scheme, and the preamble, and the encoded and modulated uplink data are transmitted. For example, one modulation and coding scheme for uplink data transmission of an initial access is specified in the protocol, or indicated in the information broadcasted by the gNB, the uplink data are encoded and modulated using the modulation and coding scheme, and the preamble, and the encoded and modulated uplink data are transmitted; or a modulation and coding scheme for uplink data transmission of an initial access is specified in the protocol, and indicated in the information broadcasted by the gNB, the uplink data are encoded and modulated using the modulation and coding scheme, and the preamble, and the encoded and modulated uplink data are transmitted.

In the embodiment of the invention, the modulation and coding scheme for uplink data is determined for uplink data transmission of an initial access according to the protocol specification, and/or the information broadcasted by the gNB so that the uplink data can be encoded and modulated.

### Second Embodiment

In order to determine the modulation and coding scheme of uplink data conveniently and rapidly, further to the first embodiment above, in the second embodiment of the invention, the determining the modulation and coding scheme of uplink data according to the protocol specification, and/or the information broadcasted by the gNB includes: selecting one of at least one modulation and coding scheme specified in the protocol and/or broadcasted by the gNB as the modulation and coding scheme of uplink data.

Particularly one modulation and coding scheme can be specified in the protocol specification and/or broadcasted by the gNB, and if one modulation and coding scheme is specified in the protocol or broadcasted by the gNB, then the UE will determine the modulation and coding scheme of uplink data by determining the modulation and coding scheme specified in the protocol or broadcasted by the gNB as the modulation and coding scheme of uplink data.

At least two modulation and coding schemes can be specified in the protocol specification and/or the gNB broadcast, the UE can determine the modulation and coding scheme of uplink data by selecting randomly one of the at least two modulation and coding schemes as the modulation and coding scheme of uplink data.

For example, three modulation and coding schemes are specified in the protocol and/or broadcasted by the gNB as a modulation and coding scheme 1, a modulation and coding scheme 2, and a modulation and coding scheme 3 respectively, the UE can determine the modulation and coding scheme of uplink data by selecting randomly one of the modulation and coding scheme 1, the modulation and coding scheme 2, and the modulation and coding scheme 3 as the modulation and coding scheme of uplink data, and for example, selecting the modulation and coding scheme 2 as the modulation and coding scheme of uplink data.

### Third Embodiment

In order to determine the modulation and coding scheme of uplink data conveniently and rapidly, further to the embodiments above, in the third embodiment of the invention, the method further includes: determining the modulation and coding scheme of uplink data according to a correspondence relationship between resources and modulation and coding schemes specified in the protocol specification and/or broadcasted by the gNB.

Particularly the correspondence relationship between resources and modulation and coding schemes can be specified in the protocol and/or broadcasted by the gNB, and at least one modulation and coding scheme can be specified in the protocol and/or broadcasted by the gNB, and the at least one modulation and coding scheme refers to candidate modulation and coding schemes, i.e., a candidate set of modulation and coding schemes, so the UE can determine the modulation and coding scheme of uplink data by selecting a corresponding modulation and coding scheme in the candidate set according to the correspondence relationship between resources and modulation and coding schemes, and the candidate set of modulation and coding schemes.

For example, the correspondence relationship between resources and modulation and coding schemes specified in the protocol and/or broadcasted by the gNB can include Resource A-Modulation and coding Scheme 1, Resource B-Modulation and coding Scheme 2, Resource C-Modulation and coding Scheme 3, and Resource D-Modulation and coding Scheme 4. The candidate set of modulation and coding schemes can include the modulation and coding scheme 1 and the modulation and coding scheme 3, the UE can determine the modulation and coding scheme of uplink data by determining the modulation and coding scheme of uplink data according to Resource A-Modulation and coding Scheme 1, and Resource C-Modulation and coding Scheme 3.

In the embodiment of the invention, the resources include at least one of: Preambles, and time and frequency resources for transmitting preambles.

The particular correspondence relationship between resources and modulation and coding schemes can be a correspondence relationship between preambles and modulation and coding schemes, or can be a correspondence relationship between time and frequency resources for transmitting preambles and modulation and coding schemes, or can be a correspondence relationship between preambles and time and frequency resources for transmitting the preambles, and modulation and coding schemes, as described below respectively in respective embodiments.

### Fourth Embodiment

In order to determine the modulation and coding scheme of uplink data conveniently and rapidly, further to the embodiments above, in the embodiment of the invention, if the resources are preambles, then the determining the modulation and coding scheme of uplink data includes:
Determining a modulation and coding scheme corresponding to the preamble in the uplink data transmission as the modulation and coding scheme of uplink data according to a correspondence relationship between preambles and modulation and coding schemes; or
Selecting a modulation and coding scheme in a modulation and coding scheme group corresponding to the preamble in the uplink data transmission as the modulation and coding scheme of uplink data according to the preamble in the uplink data transmission, and a correspondence relationship between preambles and modulation and coding scheme groups, where each modulation and coding scheme group includes at least two modulation and coding schemes.

Particularly if the resources are preambles, the correspondence relationship between resources and modulation and coding schemes is a correspondence relationship between preambles and modulation and coding schemes, and at least one modulation and coding scheme, i.e., a candidate set of modulation and coding schemes, is specified in the protocol and/or broadcasted by the gNB, then the UE to transmit uplink data of an initial access determines a modulation and coding scheme corresponding to a preamble in the uplink data transmission, encodes and modulates the uplink data using the determined modulation and coding scheme in the candidate set, and transmits the preamble, and the encoded and modulated uplink data to the gNB. Upon reception of the preamble, and the encoded and modulated uplink data transmitted by the UE, the gNB demodulates and decodes the received uplink data using the modulation and coding scheme corresponding to the preamble in the uplink data transmission according to the correspondence relationship between preambles and modulation and coding schemes specified in the protocol and/or broadcasted by the gNB, the candidate set of modulation and coding schemes, and the preamble.

FIG. 4 is a schematic diagram of a correspondence relationship between preambles and modulation and coding schemes according to an embodiment of the invention, where each preamble corresponds to a Modulation and Coding Scheme (MCS), and particularly the correspondence relationship between preambles and modulation and coding schemes can be a correspondence relationship between preamble sequences and modulation and coding schemes; and as illustrated in FIG. 4, a preamble sequence 1 corresponds to MCS1, a preamble sequence 2 corresponds to MCS2, . . . , and a preamble sequence N corresponds to MCS N. The UE to transmit uplink data of an initial access determines a preamble in uplink data transmission, and then can determine a modulation and coding scheme corresponding to the preamble according to the correspondence relationship as illustrated in FIG. 4; and for example, the preamble in the uplink data transmission is the preamble 2, so the determined modulation and coding scheme is MCS2, and the UE encodes and modulates the uplink data using MCS2, and transmits the preamble, and the encoded and modulated uplink data.

Moreover if the resources are preambles, the correspondence relationship between resources and modulation and coding schemes is a correspondence relationship between preambles and modulation and coding scheme groups, where each modulation and coding scheme group includes at least two modulation and coding schemes, and at least one modulation and coding scheme is specified in the protocol and/or broadcasted by the gNB, where the at least one modulation and coding scheme includes candidate modulation and coding schemes, then the UE to transmit uplink data of an initial access will determine a modulation and coding scheme group corresponding to a preamble in the uplink data transmission, select a modulation and coding scheme in the candidate set of modulation and coding schemes from the modulation and coding scheme group, encode and modulate the uplink data using the modulation and coding scheme, and transmit the preamble, and the encoded and modulated uplink data to the gNB. Upon reception of the preamble, and the encoded and modulated uplink data, transmitted by the UE, the gNB demodulates and decodes the received uplink data using the respective modulation and coding schemes in the modulation and coding scheme group corresponding to the preamble in the uplink data transmission sequentially according to the correspondence relationship between preambles and modulation and coding scheme groups specified in the protocol and/or broadcasted by the gNB, the candidate set of modulation and coding schemes, and the preamble until the uplink data are demodulated and decoded successfully.

FIG. 5 is a schematic diagram of a correspondence relationship between preambles and modulation and coding scheme groups according to an embodiment of the invention, where each preamble corresponds to a Modulation and Coding Scheme (MCS), and each MCS group includes at least two modulation and coding schemes; and particularly the correspondence relationship between preambles and MCS groups can be a correspondence relationship between preamble sequences and MCS groups, and as illustrated in FIG. 5, a preamble sequence 1 corresponds to an MCS group 1, a preamble sequence 2 corresponds to an MCS group 2, . . . , and a preamble sequence N corresponds to an MCS group N. The UE to transmit uplink data of an initial access determines a preamble in uplink data transmission, and then can determine a modulation and coding scheme group corresponding to the preamble according to the correspondence relationship as illustrated in FIG. 5, and for example, the preamble in the uplink data transmission is the preamble 2, then the determined modulation and coding scheme is the MCS group 2, and the UE selects randomly a modulation and coding scheme in the MCS group 2; and for example, the modulation and coding scheme 2 in the MCS group 2 lies in the candidate set, so the UE can encode and modulate the uplink data using the modulation and coding scheme 2, and transmit the preamble, and the encoded and modulated uplink data.

### Fifth Embodiment

In order to determine the modulation and coding scheme of uplink data conveniently and rapidly, further to the embodiments above, in the embodiment of the invention, if the resources are time and frequency resources for transmitting preambles, then the determining the modulation and coding scheme of uplink data includes:
Determining a modulation and coding scheme corresponding to a time and frequency resource group including a time and frequency resource for transmitting a preamble in the uplink data transmission as the modulation and coding scheme of uplink data according to the preamble in the uplink data transmission, and a correspondence relationship between time and frequency resource groups and modulation and coding schemes; or
Selecting a modulation and coding scheme in a modulation and coding scheme group corresponding to a time and frequency resource group including a time and frequency resource for transmitting the preamble in the uplink data transmission as the modulation and coding scheme of uplink data according to the time and frequency resource for transmitting the preamble, and a correspondence relationship between time and frequency resource groups and modulation and coding scheme groups, where each modulation and coding scheme group includes at least two modulation and coding schemes.

Particularly if the resources are time and frequency resources for transmitting preambles, i.e., time and frequency resources occupied by preambles, and for example, the correspondence relationship between resources and modulation and coding schemes is a correspondence relationship between time and frequency resource groups and modulation and coding schemes, and at least one modulation and coding scheme, i.e., a candidate set of modulation and coding schemes, is specified in the protocol, and/or broadcasted by the gNB, then the UE to transmit uplink data of an initial access will determine a time and frequency resource group including a time and frequency resource occupied by a preamble in the uplink data transmission, and determine a modulation and coding scheme corresponding to the time and frequency resource group, and the modulation and coding scheme lies in the candidate set, so the UE encodes and modulates the uplink data using the modulation and coding scheme, and transmits the preamble, and the encoded and modulated uplink data to the gNB. Upon reception of the preamble, and the encoded and modulated uplink data, transmitted by the UE, the gNB demodulates and decodes the received uplink data using the modulation and coding scheme corresponding to the time and frequency resource group including the time and frequency resource occupied by the preamble in the uplink data transmission according to correspondence relationship between the time and frequency resource groups and modulation and coding schemes specified in the protocol and/or broadcasted by the gNB, the candidate set of modulation and coding schemes, and the preamble.

FIG. 6 is a schematic diagram of a correspondence relationship between time and frequency resource groups and modulation and coding schemes according to an embodiment of the invention, where each time and frequency resource group corresponds to an MCS, and particularly as illustrated in FIG. 6, a time and frequency resource group 1 corresponds to MCS1, a time and frequency resource group 2 corresponds to MCS2, . . . , and a time and frequency resource group N corresponds to MCS N. The UE to transmit uplink data of an initial access determines a time and frequency resource occupied by a preamble in uplink data transmission, and then determines a time and frequency resource group including the time and frequency resource, and can determine a modulation and coding scheme corresponding to the time and frequency resource group according to the correspondence relationship as illustrated in FIG. 6; and for example, the time and frequency resource group including the time and frequency resource occupied by the preamble in the uplink data transmission is the time and frequency resource group 2, so the modulation and coding scheme is MCS2 which lies in the candidate set, and the UE encodes and modulates the uplink data using MCS2, and transmits the preamble, and the encoded and modulated uplink data.

Moreover if the resources are time and frequency resources for transmitting preambles, i.e., time and frequency resources occupied by preambles, the correspondence relationship between resources and modulation and coding schemes is a correspondence relationship between time and frequency resource groups and modulation and coding scheme groups, where each modulation and coding scheme group includes at least two modulation and coding schemes, and at least one modulation and coding scheme, i.e., a candidate set of modulation and coding schemes, is specified in the protocol and/or broadcasted by the gNB, then the UE to transmit uplink data of an initial access will determine a modulation and coding scheme group corresponding to a time and frequency resource group including a time and frequency resource occupied by a preamble in the uplink data transmission, select a modulation and coding scheme in the candidate set of modulation and coding schemes from the modulation and coding scheme group, encode and modulate the uplink data using the selected modulation and coding scheme, and transmit the preamble, and the encoded and modulated uplink data to the gNB. Upon reception of the preamble, and the encoded and modulated uplink data, transmitted by the UE, the gNB demodulates and decodes the received uplink data using the respective modulation and coding schemes in the modulation and coding scheme group corresponding to the time and frequency resource group including the time and frequency resource occupied by the preamble in the uplink data transmission sequentially according to the correspondence relationship between time and frequency resource groups and modulation and coding scheme groups specified in the protocol and/or broadcasted by the gNB, the candidate set of modulation and coding schemes, and the preamble until the uplink data are demodulated and decoded successfully.

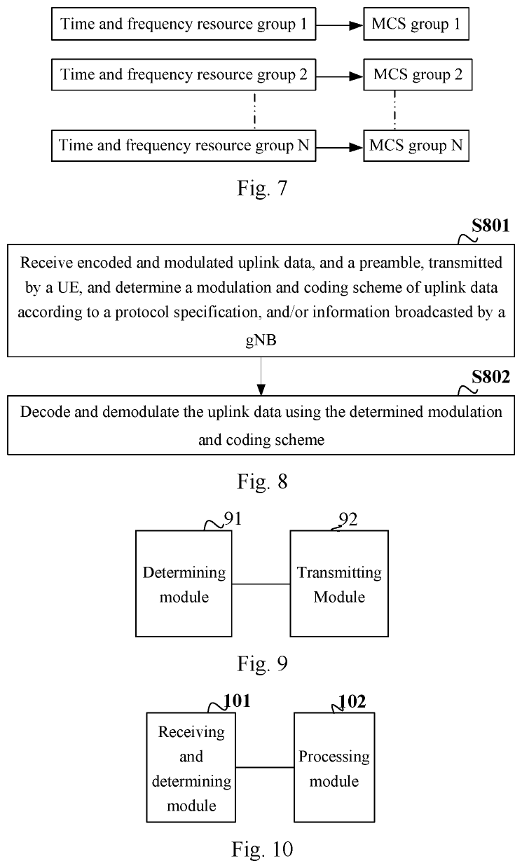

FIG. 7 is a schematic diagram of a correspondence relationship between time and frequency resource groups and modulation and coding scheme groups according to an embodiment of the invention, where each time and frequency resource group corresponds to a Modulation and Coding Scheme (MCS) group, and each MCS group includes at least two modulation and coding schemes; and particularly as illustrated in FIG. 7, a time and frequency resource group 1 corresponds to an MCS group 1, a time and frequency resource group 2 corresponds to an MCS group 2, . . . , and a time and frequency resource group N corresponds to an MCS group N. The UE to transmit uplink data of an initial access determines a time and frequency resource occupied by a preamble in uplink data transmission, and then determines a time and frequency resource group including the time and frequency resource, and can determine a modulation and coding scheme group corresponding to the time and frequency resource group according to the correspondence relationship as illustrated in FIG. 7; and for example, the time and frequency resource group including the time and frequency resource occupied by the preamble in the uplink data transmission is the time and frequency resource group 2, and the UE selects a modulation and coding scheme in the MCS group 2, and for example, the modulation and coding scheme 2 in the MCS group 2 lies in the candidate set, so the UE can encode and modulate the uplink data using the modulation and coding scheme 2, and transmit the preamble, and the encoded and modulated uplink data.

### Sixth Embodiment

In order to determine the modulation and coding scheme of uplink data conveniently and rapidly, further to the embodiments above, in the embodiment of the invention, if the resources are preambles, and time and frequency resources for transmitting the preambles, then the determining the modulation and coding scheme of uplink data will include:
Determining a modulation and coding scheme corresponding to a preamble in the uplink data transmission, and a time and frequency resource group including a time and frequency resource for transmitting the preamble, as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding schemes; or
Selecting a modulation and coding scheme in a modulation and coding scheme group corresponding to a preamble in the uplink data transmission, and a time and frequency resource group including a time and frequency resource for transmitting the preamble, as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding scheme groups, where each modulation and coding scheme group includes at least two modulation and coding schemes.

Particularly if the resources are preambles, and time and frequency resources for transmitting the preambles, i.e., time and frequency resources occupied by the preambles, the correspondence relationship between resources and modulation and coding schemes is a correspondence relationship between preambles and time and frequency resource groups, and modulation and coding schemes, and at least one modulation and coding scheme, i.e., a candidate set of modulation and coding schemes, is specified in the protocol and/or broadcasted by the gNB, then the UE to transmit uplink data of an initial access will determine a time and frequency resource group including a time and frequency resource occupied by a preamble in the uplink data transmission, and then determine a modulation and coding scheme corresponding to the preamble and the time and frequency resource group, and the modulation and coding scheme lies in the candidate set, so the UE can encode and modulate the uplink data using the modulation and coding scheme, and transmit the preamble, and the encoded and modulated uplink data to the gNB. Upon reception of the preamble, and the encoded and modulated uplink data to the gNB, transmitted by the UE, the gNB demodulates and decodes the received uplink data using the modulation and coding scheme corresponding to the preamble in the uplink data transmission, and the time and frequency resource group including the time and frequency resource occupied by the preamble according to the correspondence relationship between preambles and time and frequency resource groups, and modulation and coding schemes specified in the protocol and/or broadcasted by the gNB, the candidate set of modulation and coding schemes, the preamble in the uplink data transmission, and the time and frequency resource group including the time and frequency resource occupied by the preamble.

Moreover if the resources are preambles, and time and frequency resources for transmitting the preambles, i.e., time and frequency resources occupied by the preambles, the correspondence relationship between resources and modulation and coding schemes is a correspondence relationship between preambles and time and frequency resource groups, and modulation and coding scheme groups, where each modulation and coding scheme group includes at least two modulation and coding schemes, and at least one modulation and coding scheme, i.e., a candidate set of modulation and coding schemes, is specified in the protocol and/or broadcasted by the gNB, then the UE to transmit uplink data of an initial access will determine a modulation and coding scheme group corresponding to a preamble in the uplink data transmission, and a time and frequency resource group including a time and frequency resource occupied by the preamble, select a modulation and coding scheme in the candidate set from the modulation and coding scheme group, encode and modulate the uplink data using the modulation and coding scheme, and transmit the preamble, and the encoded and modulated uplink data to the gNB. Upon reception of the preamble, and the encoded and modulated uplink data, transmitted by the UE, the gNB demodulates and decodes the received uplink data using the respective modulation and coding schemes in the modulation and coding scheme group corresponding to the preamble in the uplink data transmission, and the time and frequency resource group including the time and frequency resource occupied by the preamble sequentially according to the correspondence relationship between preambles and time and frequency resource groups, and modulation and coding scheme groups specified in the protocol and/or broadcasted by the gNB, the preamble in the uplink data transmission, the time and frequency resource group including the time and frequency resource occupied by the preamble, and the candidate set of modulation and coding schemes until the uplink data are demodulated and decoded successfully.

### Seventh Embodiment

FIG. 8 is a schematic diagram of a data receiving process according to a seventh embodiment of the invention, where the process includes the following operations.

The operation S801 is to receive encoded and modulated uplink data, and a preamble, transmitted by a UE, and to determine a modulation and coding scheme of uplink data according to a protocol specification, and/or information broadcasted by a gNB.

In the embodiment of the invention, the modulation and coding scheme can be specified in the protocol, or can be broadcasted by the gNB, or can be specified in the protocol, and broadcasted by the gNB.

One or more modulation and coding schemes can be specified in the protocol, and if only one modulation and coding scheme is specified in the protocol for uplink data of an initial access, then the gNB will determine the modulation and coding scheme as the modulation and coding scheme of uplink data; and if more than one modulation and coding scheme is specified in the protocol, then the gNB will decode and demodulate the encoded and modulated data using the respective specified modulation and coding schemes sequentially, and determine the modulation and coding scheme with a decoding and demodulation success as the modulation and coding scheme of uplink data.

The gNB can broadcast one or more modulation and coding schemes, and for uplink data of an initial access, if the gNB broadcasts only one modulation and coding scheme, then the gNB will determine the modulation and coding scheme as the modulation and coding scheme of uplink data; and if the gNB broadcasts more than one modulation and coding scheme, then the gNB will decode and demodulate the encoded and modulated data using the respective broadcasted modulation and coding schemes sequentially, and determine the modulation and coding scheme with a decoding and demodulation success as the modulation and coding scheme of uplink data.

If the modulation and coding scheme or schemes is or are specified in the protocol, and broadcasted by the gNB, then the gNB will decode and demodulate the encoded and modulated data using respective modulation and coding schemes in an intersection set of the modulation and coding schemes specified in the protocol and broadcasted by the gNB sequentially, and determine the modulation and coding scheme with a decoding and demodulation success as the modulation and coding scheme of uplink data.

The operation S802 is to decode and demodulate the uplink data using the determined modulation and coding scheme.

The data receiving method according to the embodiment of the invention is applicable to the gNB, and the modulation and coding scheme or schemes of uplink data to be used by the UE and the gNB for uplink data transmission of an initial access is or are pre-specified in the data transmission protocol, or the gNB broadcasts and indicates the modulation and coding scheme or schemes of uplink data for uplink data transmission of an initial access.

Particularly the gNB receives the encoded and modulated uplink data, and the preamble, transmitted by the UE, and determines the modulation and coding scheme of uplink data according to the modulation and coding scheme or schemes of uplink data specified in the protocol, or carried in the information broadcasted by the gNB; and decodes and demodulates the uplink data using the determined modulation and coding scheme. For example, one modulation and coding scheme for uplink data transmission of an initial access is specified in the protocol, or indicated in the information broadcasted by the gNB, and the gNB receives the encoded and modulated uplink data transmitted by the UE, and decodes and demodulates the uplink data using the modulation and coding scheme; or modulation and coding schemes for uplink data transmission of an initial access is specified in the protocol, and indicated in the information broadcasted by the gNB, and the gNB can decode and demodulate the uplink data using the respective modulation and coding schemes sequentially.

In the embodiment of the invention, the modulation and coding scheme for uplink data is determined for uplink data transmission of an initial access according to the protocol specification, and/or the information broadcasted by the gNB so that the uplink data can be encoded and modulated.

### Eighth Embodiment

In order to determine the modulation and coding scheme of uplink data conveniently and rapidly, further to the embodiments above, in the embodiment of the invention, the determining the modulation and coding scheme of uplink data according to the protocol specification, and/or the information broadcasted by the gNB includes:
Selecting one of at least one modulation and coding scheme specified in the protocol and/or broadcasted by the gNB as the modulation and coding scheme of uplink data.

Particularly one modulation and coding scheme can be specified in the protocol specification and/or the gNB broadcast, and if one modulation and coding scheme is specified in the protocol or broadcasted by the gNB, then the gNB will determine the modulation and coding scheme of uplink data by determining the modulation and coding scheme specified in the protocol or broadcasted by the gNB as the modulation and coding scheme of uplink data.

At least two modulation and coding schemes can be specified in the protocol specification and/or the gNB broadcast, so the gNB can determine the modulation and coding scheme of uplink data by decoding and demodulating the uplink data using each of the at least two modulation and coding schemes sequentially, and determining the corresponding modulation and coding scheme with which the uplink data is decoded and demodulated successfully as the modulation and coding scheme of uplink data.

For example, three modulation and coding schemes are specified in the protocol and/or broadcasted by the gNB as a modulation and coding scheme 1, a modulation and coding scheme 2, and a modulation and coding scheme 3 respectively, so the gNB can decode and demodulate the uplink data using each of the modulation and coding scheme 1, the modulation and coding scheme 2, and the modulation and coding scheme 3 sequentially, and determine the corresponding modulation and coding scheme with which the uplink data is decoded and demodulated successfully as the modulation and coding scheme of uplink data. For example, the gNB decodes and demodulates the uplink data successfully using the modulation and coding scheme 2, and determines the modulation and coding scheme 2 as the modulation and coding scheme of uplink data.

### Ninth Embodiment

In order to determine the modulation and coding scheme of uplink data conveniently and rapidly, further to the embodiments above, in the embodiment of the invention, the method further includes:
Determining the modulation and coding scheme of uplink data according to a correspondence relationship between resources and modulation and coding schemes specified in the protocol and/or broadcasted by the gNB.

Particularly the correspondence relationship between resources and modulation and coding schemes can be specified in the protocol and/or broadcasted by the gNB, and at least one modulation and coding scheme can be specified in the protocol and/or broadcasted by the gNB, and the at least one modulation and coding scheme includes candidate modulation and coding schemes, i.e., a candidate set of modulation and coding schemes, so the gNB can determine the modulation and coding scheme of uplink data by decoding and demodulating the uplink data using the respective modulation and coding schemes in the candidate set of modulation and coding schemes sequentially according to the correspondence relationship between resources and modulation and coding schemes, and the candidate set of modulation and coding schemes, and determining the corresponding modulation and coding scheme with which the uplink data is decoded and demodulated successfully as the modulation and coding scheme of uplink data.

For example, the correspondence relationship between resources and modulation and coding schemes specified in the protocol and/or broadcasted by the gNB can include Resource

A-Modulation and coding Scheme 1, Resource B-Modulation and coding Scheme 2, Resource C-Modulation and coding Scheme 3, and Resource D-Modulation and coding Scheme 4, and the candidate set of modulation and coding schemes includes the modulation and coding scheme 1 and the modulation and coding scheme 3, so the gNB can determine the modulation and coding scheme of uplink data by determining the modulation and coding scheme of uplink data according to Resource A-Modulation and coding Scheme 1, and Resource C-Modulation and coding Scheme 3.

In the embodiment of the invention, the resources include at least one of:
Preambles, and time and frequency resources for transmitting preambles.

The particular correspondence relationship between resources and modulation and coding schemes can be a correspondence relationship between preambles and modulation and coding schemes, or can be a correspondence relationship between time and frequency resources for transmitting preambles and modulation and coding schemes, or can be a correspondence relationship between preambles and time and frequency resources for transmitting the preambles, and modulation and coding schemes, as described below respectively in respective embodiments.

### Tenth Embodiment

In order to determine the modulation and coding scheme of uplink data conveniently and rapidly, further to the embodiments above, in the embodiment of the invention, if the resources are preambles, then the determining the modulation and coding scheme of uplink data will include:
Determining a modulation and coding scheme corresponding to a preamble in the uplink data transmission as the modulation and coding scheme of uplink data according to a correspondence relationship between preambles and modulation and coding schemes; or
Decoding and demodulating the uplink data using each of at least two modulation and coding schemes in a modulation and coding scheme group corresponding to a preamble in the uplink data transmission sequentially according to the preamble in the uplink data transmission, and a correspondence relationship between preambles and modulation and coding scheme groups, and determining the corresponding modulation and coding scheme with which the uplink data is decoded and demodulated successfully as the modulation and coding scheme of uplink data.

Particularly if the resources are preambles, the correspondence relationship between resources and modulation and coding schemes is a correspondence relationship between preambles and modulation and coding schemes, and at least one modulation and coding scheme, i.e., a candidate set of modulation and coding schemes, is specified in the protocol and/or broadcasted by the gNB, then the UE to transmit uplink data of an initial access will determine a modulation and coding scheme corresponding to a preamble in the uplink data transmission, encode and modulate the uplink data using the determined modulation and coding scheme in the candidate set, and transmit the preamble, and the encoded and modulated uplink data to the gNB. Upon reception of the preamble, and the encoded and modulated uplink data transmitted by the UE, the gNB demodulates and decodes the received uplink data using the modulation and coding scheme corresponding to the preamble in the uplink data transmission according to the correspondence relationship between preambles and modulation and coding schemes specified in the protocol and/or broadcasted by the gNB, the candidate set of modulation and coding schemes, and the preamble.

FIG. 4 is a schematic diagram of a correspondence relationship between preambles and modulation and coding schemes according to an embodiment of the invention, where each preamble corresponds to an MCS, and particularly the correspondence relationship between preambles and modulation and coding schemes can be a correspondence relationship between preamble sequences and modulation and coding schemes; and as illustrated in FIG. 4, a preamble sequence 1 corresponds to MCS1, a preamble sequence 2 corresponds to MCS2, . . . , and a preamble sequence N corresponds to MCS N. For encoded and modulated uplink data, and a preamble, transmitted by the UE, the gNB can determine a modulation and coding scheme corresponding to the preamble according to the correspondence relationship as illustrated in FIG. 4; and for example, the preamble in the uplink data transmission is the preamble 2, so the modulation and coding scheme is MCS2, and the gNB decodes and demodulates the encoded and modulated uplink data transmitted by the UE, using MCS2.

Moreover if the resources are preambles, the correspondence relationship between resources and modulation and coding schemes is a correspondence relationship between preambles and modulation and coding scheme groups, where each modulation and coding scheme group includes at least two modulation and coding schemes, and at least one modulation and coding scheme is specified in the protocol and/or broadcasted by the gNB, where the at least one modulation and coding scheme refers to candidate modulation and coding schemes, then the UE to transmit uplink data of an initial access will determine a modulation and coding scheme group corresponding to a preamble in the uplink data transmission, select a modulation and coding scheme in the candidate set of modulation and coding schemes from the modulation and coding scheme group, encode and modulate the uplink data using the modulation and coding scheme, and transmit the preamble, and the encoded and modulated uplink data to the gNB. Upon reception of the preamble, and the encoded and modulated uplink data, transmitted by the UE, the gNB demodulates and decodes the received uplink data using each of the at least two modulation and coding schemes in the modulation and coding scheme group corresponding to the preamble in the uplink data transmission sequentially according to the correspondence relationship between preambles and modulation and coding scheme groups specified in the protocol and/or broadcasted by the gNB, the candidate set of modulation and coding schemes, and the preamble until the uplink data are demodulated and decoded successfully.

FIG. 5 is a schematic diagram of a correspondence relationship between preambles and modulation and coding scheme groups according to an embodiment of the invention, where each preamble corresponds to an MCS group, and each MCS group includes at least two modulation and coding schemes; and particularly the correspondence relationship between preambles and MCS groups can be a correspondence relationship between preamble sequences and MCS groups, and as illustrated in FIG. 5, a preamble sequence 1 corresponds to an MCS group 1, a preamble sequence 2 corresponds to an MCS group 2, . . . , and a preamble sequence N corresponds to an MCS group N. For encoded and modulated uplink data, and a preamble, transmitted by the UE, the gNB can determine a modulation and coding scheme group corresponding to the preamble according to the correspondence relationship as illustrated in FIG. 5; and for example, the preamble in the uplink data transmission is the preamble 2, so the modulation and coding scheme group is the MCS group 2, and the gNB decodes and demodulates the received uplink data using the at least two modulation and coding schemes in the MCS group 2 sequentially until the uplink data are demodulated and decoded successfully.

### Eleventh Embodiment

In order to determine the modulation and coding scheme of uplink data conveniently and rapidly, further to the embodiments above, in the embodiment of the invention, if the resources are time and frequency resources for transmitting preambles, then the determining the modulation and coding scheme of uplink data will include:
Determining a modulation and coding scheme corresponding to a time and frequency resource group including a time and frequency resource for transmitting a preamble in the uplink data transmission as the modulation and coding scheme of uplink data according to the preamble in the uplink data transmission, and a correspondence relationship between time and frequency resource groups and modulation and coding schemes; or
Decoding and demodulating the uplink data using each of at least two modulation and coding schemes in a modulation and coding scheme group corresponding to a time and frequency resource group including a time and frequency resource for transmitting the preamble in the uplink data transmission sequentially according to the time and frequency resource for transmitting the preamble, and a correspondence relationship between time and frequency resource groups and modulation and coding scheme groups, and determining the corresponding modulation and coding scheme with which the uplink data is decoded and demodulated successfully as the modulation and coding scheme of uplink data.

Particularly if the resources are time and frequency resources for transmitting preambles, i.e., time and frequency resources occupied by preambles, and for example, the correspondence relationship between resources and modulation and coding schemes is a correspondence relationship between time and frequency resource groups and modulation and coding schemes, and at least one modulation and coding scheme, i.e., a candidate set of modulation and coding schemes, is specified in the protocol, and/or broadcasted by the gNB, then the UE to transmit uplink data of an initial access will determine a modulation and coding scheme corresponding to a time and frequency resource group including a time and frequency resource occupied by a preamble in the uplink data transmission, and the time and frequency resource group lies in the candidate set, so the UE encodes and modulates the uplink data using the modulation and coding scheme, and transmits the preamble, and the encoded and modulated uplink data to the gNB. Upon reception of the preamble, and the encoded and modulated uplink data, transmitted by the UE, the gNB demodulates and decodes the received uplink data using the modulation and coding scheme corresponding to the time and frequency resource group including the time and frequency resource occupied by the preamble in the uplink data transmission according to the correspondence relationship between time and frequency resource groups and modulation and coding schemes specified in the protocol and/or broadcasted by the gNB, the candidate set of modulation and coding schemes, and the preamble.

FIG. 6 is a schematic diagram of a correspondence relationship between time and frequency resource groups and modulation and coding schemes according to an embodiment of the invention, where each time and frequency resource group corresponds to an MCS, and particularly as illustrated in FIG. 6, a time and frequency resource group 1 corresponds to MCS1, a time and frequency resource group 2 corresponds to MCS2, . . . , and a time and frequency resource group N corresponds to MCS N. For encoded and modulated uplink data, and a preamble, transmitted by the UE, the gNB determines a time and frequency resource occupied by the preamble in uplink data transmission, and then determines a time and frequency resource group including the time and frequency resource, and can determine a modulation and coding scheme corresponding to the time and frequency resource group according to the correspondence relationship as illustrated in FIG. 6; and for example, the time and frequency resource group including the time and frequency resource occupied by the preamble in the uplink data transmission is the time and frequency resource group 2, so the modulation and coding scheme is MCS2 which lies in the candidate set, and the gNB decodes and demodulates the encoded and modulated uplink data transmitted by the UE, using MCS2.

Moreover if the resources are time and frequency resources for transmitting preambles, i.e., time and frequency resources occupied by preambles, the correspondence relationship between resources and modulation and coding schemes is a correspondence relationship between time and frequency resource groups and modulation and coding scheme groups, where each modulation and coding scheme group includes at least two modulation and coding schemes, and at least one modulation and coding scheme, i.e., a candidate set of modulation and coding schemes, is specified in the protocol and/or broadcasted by the gNB, then the UE to transmit uplink data of an initial access will determine a modulation and coding scheme group corresponding to a time and frequency resource group including a time and frequency resource occupied by the preamble in the uplink data transmission, select a modulation and coding scheme in the candidate set of modulation and coding schemes from the modulation and coding scheme group, encode and modulate the uplink data using the modulation and coding scheme, and transmit the preamble, and the encoded and modulated uplink data to the gNB. Upon reception of the preamble, and the encoded and modulated uplink data, transmitted by the UE, the gNB demodulates and decodes the received uplink data using each of the at least two modulation and coding schemes in the modulation and coding scheme group corresponding to the time and frequency resource group including the time and frequency resource occupied by the preamble in the uplink data transmission sequentially according to the correspondence relationship between time and frequency resource groups and modulation and coding scheme groups specified in the protocol and/or broadcasted by the gNB, the candidate set of modulation and coding schemes, and the preamble until the uplink data are demodulated and decoded successfully.

FIG. 7 is a schematic diagram of a correspondence relationship between time and frequency resource groups and modulation and coding scheme groups according to an embodiment of the invention, where each time and frequency resource group corresponds to an MCS group, and each MCS group includes at least two modulation and coding schemes; and particularly as illustrated in FIG. 7, a time and frequency resource group 1 corresponds to an MCS group 1, a time and frequency resource group 2 corresponds to an MCS group 2, . . . , and a time and frequency resource group N corresponds to an MCS group N. For encoded and modulated uplink data, and a preamble, transmitted by the UE, the gNB determines a time and frequency resource occupied by the preamble in uplink data transmission, and then determines a time and frequency resource group including the time and frequency resource, and can determine a modulation and coding scheme group corresponding to the time and frequency resource group according to the correspondence relationship as illustrated in FIG. 7; and for example, the time and frequency resource group including the time and frequency resource occupied by the preamble in the uplink data transmission is the time and frequency resource group 2, and MCS2 lies in the candidate set, so the modulation and coding scheme group is the MCS group 2, and the gNB demodulates and decodes the received uplink data using the at least two modulation and coding schemes in the MCS group 2 sequentially until the uplink data are demodulated and decoded successfully.

### Twelfth Embodiment

In order to determine the modulation and coding scheme of uplink data conveniently and rapidly, further to the embodiments above, in the embodiment of the invention, if the resources are preambles, and time and frequency resources for transmitting the preambles, then the determining the modulation and coding scheme of uplink data will include:
Determining a modulation and coding scheme corresponding to a preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups, and modulation and coding schemes; or
Decoding and demodulating the uplink data using each of at least two modulation and coding schemes in a modulation and coding scheme group corresponding to a preamble in the uplink data transmission, and a time and frequency resource group including a time and frequency resource for transmitting the preamble sequentially according to the preamble in the uplink data transmission, the time and frequency resource for transmitting the preamble in the uplink data transmission, and a correspondence relationship between preambles and time and frequency resource groups, and modulation and coding scheme groups, and determining the corresponding modulation and coding scheme with which the uplink data is decoded and demodulated successfully as the modulation and coding scheme of uplink data.

Particularly if the resources are preambles, and time and frequency resources for transmitting the preambles, i.e., time and frequency resources occupied by the preambles, the correspondence relationship between resources and modulation and coding schemes is a correspondence relationship between preambles and time and frequency resource groups, and modulation and coding schemes, and at least one modulation and coding scheme, i.e., a candidate set of modulation and coding schemes, is specified in the protocol and/or broadcasted by the gNB, then the UE to transmit uplink data of an initial access will determine a time and frequency resource group including a time and frequency resource occupied by a preamble in the uplink data transmission, and then determine a modulation and coding scheme corresponding to the preamble and the time and frequency resource group, and the modulation and coding scheme lies in the candidate set, so the UE can encode and modulate the uplink data using the modulation and coding scheme, and transmit the preamble, and the encoded and modulated uplink data to the gNB. Upon reception of the preamble, and the encoded and modulated uplink data, transmitted by the UE, the gNB demodulates and decodes the received uplink data using the modulation and coding scheme corresponding to the preamble in the uplink data transmission, and the time and frequency resource group including the time and frequency resource occupied by the preamble according to the correspondence relationship between preambles and time and frequency resource groups, and modulation and coding schemes specified in the protocol and/or broadcasted by the gNB, the candidate set of modulation and coding schemes, the preamble in the uplink data transmission, and the time and frequency resource group including the time and frequency resource occupied by the preamble.

Moreover if the resources are preambles, and time and frequency resources for transmitting the preambles, i.e., time and frequency resources occupied by the preambles, the correspondence relationship between resources and modulation and coding schemes is a correspondence relationship between preambles and time and frequency resource groups, and modulation and coding scheme groups, where each modulation and coding scheme group includes at least two modulation and coding schemes, and at least one modulation and coding scheme, i.e., a candidate set of modulation and coding schemes, is specified in the protocol and/or broadcasted by the gNB, then the UE to transmit uplink data of an initial access will determine a modulation and coding scheme group corresponding to a preamble in the uplink data transmission, and a time and frequency resource group including a time and frequency resource occupied by the preamble, select a modulation and coding scheme in the candidate set from the modulation and coding scheme group, encode and modulate the uplink data using the modulation and coding scheme, and transmits the preamble, and the encoded and modulated uplink data to the gNB. Upon reception of the preamble, and the encoded and modulated uplink data, transmitted by the UE, the gNB demodulates and decodes the received uplink data using each of the at least two modulation and coding schemes in the modulation and coding scheme group corresponding to the preamble in the uplink data transmission, and the time and frequency resource group including the time and frequency resource occupied by the preamble sequentially according to the correspondence relationship between preambles and time and frequency resource groups, and modulation and coding scheme groups specified in the protocol and/or broadcasted by the gNB, the preamble in the uplink data transmission, the time and frequency resource group including the time and frequency resource occupied by the preamble, and the candidate set of modulation and coding schemes until the uplink data are demodulated and decoded successfully.

### Thirteenth Embodiment

FIG. 9 is a schematic structural diagram of a data transmitting device according to an embodiment of the invention, where the device includes:
A determining module 91 configured to determine a modulation and coding scheme of uplink data for uplink data transmission of an initial access according to a protocol specification, and/or information broadcasted by a gNB; and
A transmitting module 92 configured to encode and modulate the uplink data using the determined modulation and coding scheme, and to transmit a preamble, and the encoded and modulated uplink data.

The determining module 91 is configured to select one of at least one modulation and coding scheme specified in the protocol and/or broadcasted by the gNB as the modulation and coding scheme of uplink data.

The determining module 91 is further configured to determine the modulation and coding scheme of uplink data according to a correspondence relationship between resources and modulation and coding schemes specified in the protocol and/or broadcasted by the gNB.

The determining module 91 is configured, if the resources are preambles, to determine a modulation and coding scheme corresponding to a preamble in the uplink data transmission as the modulation and coding scheme of uplink data according to a correspondence relationship between preambles and modulation and coding schemes; or to select a modulation and coding scheme in a modulation and coding scheme group corresponding to a preamble in the uplink data transmission as the modulation and coding scheme of uplink data according to the preamble in the uplink data transmission, and a correspondence relationship between preambles and modulation and coding scheme groups, where each modulation and coding scheme group includes at least two modulation and coding schemes.

The determining module 91 is configured, if the resources are time and frequency resources for transmitting preambles, to determine a modulation and coding scheme corresponding to a time and frequency resource group including a time and frequency resource for transmitting a preamble in the uplink data transmission as the modulation and coding scheme of uplink data according to the preamble in the uplink data transmission, and a correspondence relationship between time and frequency resource groups and modulation and coding scheme; or to select a modulation and coding scheme in a modulation and coding scheme group corresponding to a time and frequency resource group including a time and frequency resource for transmitting the preamble in the uplink data transmission as the modulation and coding scheme of uplink data according to the time and frequency resource for transmitting the preamble, and a correspondence relationship between time and frequency resource groups and modulation and coding scheme groups, where each modulation and coding scheme group includes at least two modulation and coding schemes.

The determining module 91 is configured, if the resources are preambles, and time and frequency resources for transmitting the preambles, to determine a modulation and coding scheme corresponding to a preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups, and modulation and coding schemes; or to select a modulation and coding scheme in a modulation and coding scheme group corresponding to a preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups, and modulation and coding scheme groups, where each modulation and coding scheme group includes at least two modulation and coding schemes.

### Fourteenth Embodiment

FIG. 10 is a schematic structural diagram of a data receiving device according to an embodiment of the invention, where the device includes:
A receiving an determining module 101 configured to receive encoded and modulated uplink data, and a preamble, transmitted by a UE, and to determine a modulation and coding scheme of uplink data according to a protocol specification, and/or information broadcasted by a gNB; and
A processing module 102 configured to decode and demodulate the uplink data using the determined modulation and coding scheme.

The receiving and determining module 101 is configured to select one of at least one modulation and coding scheme specified in the protocol and/or broadcasted by the gNB as the modulation and coding scheme of uplink data.

The receiving and determining module 101 is further configured to determine the modulation and coding scheme of uplink data according to a correspondence relationship between resources and modulation and coding schemes specified in the protocol and/or broadcasted by the gNB.

The receiving and determining module 101 is configured, if the resources are preambles, to determine a modulation and coding scheme corresponding to a preamble in the uplink data transmission as the modulation and coding scheme of uplink data according to a correspondence relationship between preambles and modulation and coding schemes; or to decode and demodulate the uplink data using each of at least two modulation and coding schemes in a modulation and coding scheme group corresponding to a preamble in the uplink data transmission sequentially according to the preamble in the uplink data transmission, and a correspondence relationship between preambles and modulation and coding scheme groups, and to determine the corresponding modulation and coding scheme with a decoding and demodulation success as the modulation and coding scheme of uplink data.

The receiving and determining module 101 is configured, if the resources are time and frequency resources for transmitting preambles, to determine a modulation and coding scheme corresponding to a time and frequency resource group including a time and frequency resource for transmitting a preamble in the uplink data transmission as the modulation and coding scheme of uplink data according to the preamble in the uplink data transmission, and a correspondence relationship between time and frequency resource groups and modulation and coding schemes; or to decode and demodulate the uplink data using each of at least two modulation and coding schemes in a modulation and coding scheme group corresponding to a time and frequency resource group including a time and frequency resource for transmitting the preamble in the uplink data transmission sequentially according to the time and frequency resource for transmitting the preamble in the uplink data transmission, and a correspondence relationship between time and frequency resource groups and modulation and coding scheme groups, and to determine the corresponding modulation and coding scheme with a decoding and demodulation success as the modulation and coding scheme of uplink data.

The receiving and determining module 101 is configured, if the resources are preambles, and time and frequency resources for transmitting the preambles, to determine a modulation and coding scheme corresponding to a preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups, and modulation and coding schemes; or to decode and demodulate the uplink data using each of at least two modulation and coding schemes in a modulation and coding scheme group corresponding to a preamble in the uplink data transmission, and a time and frequency resource group including a time and frequency resource for transmitting the preamble sequentially according to the preamble in the uplink data transmission, the time and frequency resource for transmitting the preamble in the uplink data transmission, and a correspondence relationship between preambles and time and frequency resource groups, and modulation and coding scheme groups, and to determine the corresponding modulation and coding scheme with a decoding and demodulation success as the modulation and coding scheme of uplink data.

### Fifteenth Embodiment

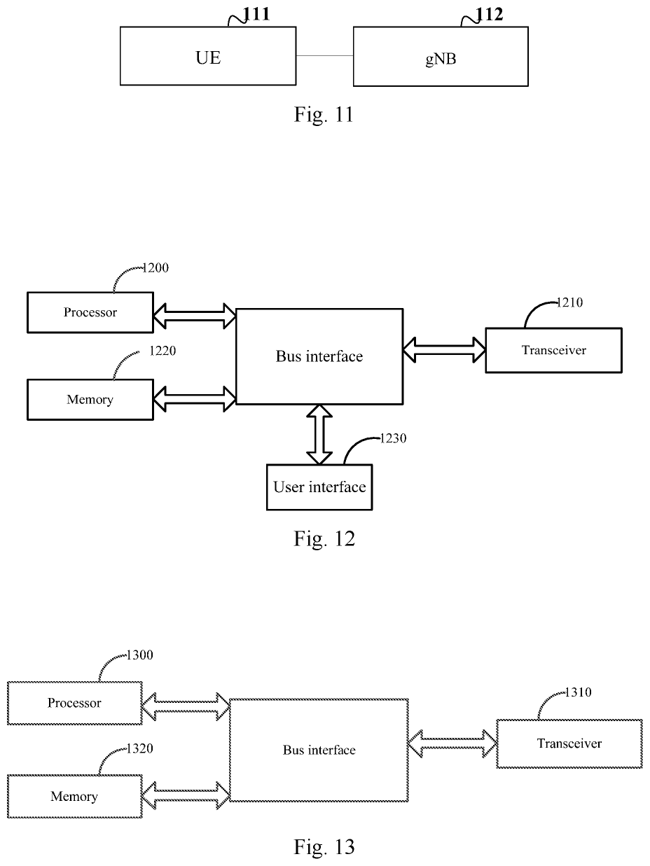

FIG. 11 is a schematic structural diagram of a data transmission system according to an embodiment of the invention, where the data transmission system includes the data transmitting device 111 applicable to a UE, as illustrated in FIG. 9, and the data receiving device 112 applicable to a gNB, as illustrated in FIG. 10.

In the data transmission method, device, and system according to the embodiments of the invention, the method includes: determining a modulation and coding scheme of uplink data for uplink data transmission of an initial access according to a protocol specification, and/or information broadcasted by a gNB; and encoding and modulating the uplink data using the determined modulation and coding scheme, and transmitting a preamble, and the encoded and modulated uplink data. In the embodiment of the invention, the modulation and coding scheme for uplink data is determined for uplink data transmission of an initial access according to the protocol specification, and/or the information broadcasted by the gNB so that the uplink data can be encoded and modulated.

Since the devices and the system are substantially similar to the method embodiments, the devices and the system have been described briefly, and reference can be made to the description of the method embodiments for details thereof

The technical solutions according to the embodiments of the invention can be embodied as follows.

FIG. 12 is a schematic structural diagram of a UE according to an embodiment of the invention, and as illustrated, the UE includes a processor 1200 and a transceiver 1210.

The processor 1200 is configured to read and execute program in a memory 1220 to determine a modulation and coding scheme of uplink data for uplink data transmission of an initial access according to a protocol specification, and/or information broadcasted by a gNB, and to encode and modulate the uplink data using the determined modulation and coding scheme.

The transceiver 1210 is configured to transmit and receive data under the control of the processor 1200, and configured to transmit a preamble, and the encoded and modulated uplink data.

In an implementation, the processor configured to determine the modulation and coding scheme of uplink data for uplink data transmission of an initial access according to the protocol specification, and/or the information broadcasted by the gNB is configured to select one of at least one modulation and coding scheme specified in the protocol and/or broadcasted by the gNB as the modulation and coding scheme of uplink data.

In an implementation, the processor is further configured to determine the modulation and coding scheme of uplink data according to a correspondence relationship between resources and modulation and coding schemes specified in the protocol and/or broadcasted by the gNB.

In an implementation, the resources include at least one of: Preambles, and time and frequency resources for transmitting preambles.

In an implementation, if the resources are preambles, then the processor configured to determine the modulation and coding scheme of uplink data is configured to determine a modulation and coding scheme corresponding to a preamble in the uplink data transmission as the modulation and coding scheme of uplink data according to a correspondence relationship between preambles and modulation and coding schemes; or to select a modulation and coding scheme in a modulation and coding scheme group corresponding to a preamble in the uplink data transmission as the modulation and coding scheme of uplink data according to the preamble in the uplink data transmission, and a correspondence relationship preambles and modulation and coding scheme groups, where each modulation and coding scheme group includes at least two modulation and coding schemes.

In an implementation, if the resources are time and frequency resources for transmitting preambles, then the processor configured to determine the modulation and coding scheme of uplink data is configured:
to determine a modulation and coding scheme corresponding to a time and frequency resource group including a time and frequency resource for transmitting a preamble in the uplink data transmission as the modulation and coding scheme of uplink data according to the preamble in the uplink data transmission, and a correspondence relationship between time and frequency resource groups and modulation and coding schemes; or
to select a modulation and coding scheme in a modulation and coding scheme group corresponding to a time and frequency resource group including a time and frequency resource for transmitting the preamble in the uplink data transmission as the modulation and coding scheme of uplink data according to the time and frequency resource for transmitting the preamble, and a correspondence relationship between time and frequency resource groups and modulation and coding scheme groups, where each modulation and coding scheme group includes at least two modulation and coding schemes.

In an implementation, if the resources are preambles, and time and frequency resources for transmitting the preambles, then the processor configured to determine the modulation and coding scheme of uplink data is configured:
to determine a modulation and coding scheme corresponding to a preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups, and modulation and coding scheme; or
to select a modulation and coding scheme in a modulation and coding scheme group corresponding to a preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups, and modulation and coding scheme groups, where each modulation and coding scheme group includes at least two modulation and coding schemes.

Here in FIG. 12, the bus architecture can include any number of interconnecting buses and bridges to particularly link together various circuits including one or more processors represented by the processor 1200, and one or more memories represented by the memory 1220. The bus architecture can further link together various other circuits, e.g., a peripheral device, a manostat, a power management circuit, etc., all of which are well known in the art, so a further description thereof will be omitted in this context. The bus interface serves as an interface. The transceiver 1210 can be a number of elements, e.g., a transmitter and a receiver, which are units for communication with various other devices over a transmission medium. For different user equipments, the user interface 1230 can also be an interface via which devices are connected internally and externally as needed, and the connected devices include but will not be limited to a keypad, a monitor, a speaker, a microphone, a joystick, etc.

The processor 1200 is responsible for managing the bus architecture and performing normal processes, and the memory 1220 can store data for use by the processor 1200 in performing the operations.

FIG. 13 is a schematic structural diagram of a gNB according to an embodiment of the invention, and as illustrated, the gNB includes a transceiver 1310 and a processor 1300.

The transceiver 1300 is configured to transmit and receive data under the control of the processor 1300, and is configured to receive encoded and modulated uplink data, and a preamble, transmitted by a UE.

The processor 1300 is configured to read and execute program in a memory 1320 to determine a modulation and coding scheme of uplink data according to a protocol specification, and/or information broadcasted by the gNB, and to decode and demodulate the uplink data using the determined modulation and coding scheme.

In an implementation, the processor configured to determine the modulation and coding scheme of uplink data according to the protocol specification, and/or the information broadcasted by the gNB is configured to select one of at least one modulation and coding scheme specified in the protocol and/or broadcasted by the gNB as the modulation and coding scheme of uplink data.

In an implementation, the processor is further configured to determine the modulation and coding scheme of uplink data according to a correspondence relationship between resources and modulation and coding schemes specified in the protocol and/or broadcasted by the gNB.

In an implementation, the resources include at least one of:
Preambles, and time and frequency resources for transmitting the preambles.

In an implementation, if the resources are preambles, then the processor configured to determine the modulation and coding scheme of uplink data is configured:
To determine a modulation and coding scheme corresponding to a preamble in the uplink data transmission as the modulation and coding scheme of uplink data according to a correspondence relationship between preambles and modulation and coding schemes; or
To decode and demodulate the uplink data using each of at least two modulation and coding schemes in a modulation and coding scheme group corresponding to a preamble in the uplink data transmission sequentially according to the preamble in the uplink data transmission, and a correspondence relationship between preambles and modulation and coding scheme groups, and to determine the corresponding modulation and coding scheme with a decoding and demodulation success as the modulation and coding scheme of uplink data.

In an implementation, if the resources are time and frequency resources for transmitting preambles, then the processor configured to determine the modulation and coding scheme of uplink data is configured:
To determine a modulation and coding scheme corresponding to a time and frequency resource group including a time and frequency resource for transmitting a preamble in the uplink data transmission as the modulation and coding scheme of uplink data according to the preamble in the uplink data transmission, and a correspondence relationship between time and frequency resource groups and modulation and coding schemes; or
To decode and demodulate the uplink data using each of at least two modulation and coding schemes in a modulation and coding scheme group corresponding to a time and frequency resource group including a time and frequency resource for transmitting the preamble in the uplink data transmission sequentially according to the time and frequency resource for transmitting the preamble in the uplink data transmission, and a correspondence relationship between time and frequency resource groups and modulation and coding scheme groups, and to determine the corresponding modulation and coding scheme with a decoding and demodulation success as the modulation and coding scheme of uplink data.

In an implementation, if the resources are preambles, and time and frequency resources for transmitting the preambles, then the processor configured to determine the modulation and coding scheme of uplink data is configured:
To determine a modulation and coding scheme corresponding to a preamble in the uplink data transmission, and a time and frequency resource group including a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups and modulation and coding schemes; or
To decode and demodulate the uplink data using each of at least two modulation and coding schemes in a modulation and coding scheme group corresponding to a preamble in the uplink data transmission, and a time and frequency resource group including a time and frequency resource for transmitting the preamble sequentially according to the preamble in the uplink data transmission, the time and frequency resource for transmitting the preamble in the uplink data transmission, and a correspondence relationship between preambles and time and frequency resource groups and modulation and coding scheme groups, and to determine the corresponding modulation and coding scheme with a decoding and demodulation success as the modulation and coding scheme of uplink data.

Here in FIG. 13, the bus architecture can include any number of interconnecting buses and bridges to particularly link together various circuits including one or more processors represented by the processor 1300, and one or more memories represented by the memory 1320.

The bus architecture can further link together various other circuits, e.g., a peripheral device, a manostat, a power management circuit, etc., all of which are well known in the art, so a further description thereof will be omitted in this context. The bus interface serves as an interface. The transceiver 1310 can be a number of elements, e.g., a transmitter and a receiver, which are units for communication with various other devices over a transmission medium. The processor 1300 is responsible for managing the bus architecture and performing normal processes, and the memory 1320 can store data for use by the processor 1300 in performing the operations.

An embodiment of the invention further provides a computer device including a memory, a processor, and computer program stored on the memory, and executable on the processor, where the processor executes the computer program to perform the data transmitting method above at the UE side.

An embodiment of the invention further provides a computer device including a memory, a processor, and computer program stored on the memory, and executable on the processor, where the processor executes the computer program to perform the data receiving method above at the gNB side.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A data transmitting method, comprising:
determining a modulation and coding scheme of uplink data for uplink data transmission of an initial access according to a protocol specification, and/or information broadcasted by a gNB (next-Generation Node B); and
encoding and modulating the uplink data using the determined modulation and coding scheme, and transmitting a preamble, and the encoded and modulated uplink data.

2. The method according to claim 1, wherein the determining the modulation and coding scheme of uplink data for uplink data transmission of an initial access according to the protocol specification, and/or the information broadcasted by the gNB comprises:
selecting one of at least one modulation and coding scheme specified in the protocol specification and/or broadcasted by the gNB as the modulation and coding scheme of uplink data; and/or
determining the modulation and coding scheme of uplink data according to a correspondence relationship between resources and modulation and coding schemes specified in the protocol specification and/or broadcasted by the gNB; wherein the resources comprise at least one of: preambles, and time and frequency resources for transmitting preambles.

3. (canceled)

4. (canceled)

5. The method according to claim 2, wherein when the resources are preambles, the determining the modulation and coding scheme of uplink data comprises:
determining a modulation and coding scheme corresponding to the preamble in the uplink data transmission as the modulation and coding scheme of uplink data according to a correspondence relationship between preambles and modulation and coding schemes; or
selecting a modulation and coding scheme in a modulation and coding scheme group corresponding to the preamble in the uplink data transmission as the modulation and coding scheme of uplink data according to the preamble in the uplink data transmission, and a correspondence relationship between preambles and modulation and coding scheme groups, wherein each modulation and coding scheme group comprises at least two modulation and coding schemes.

6. The method according to claim 2, wherein when the resources are time and frequency resources for transmitting preambles, the determining the modulation and coding scheme of uplink data comprises:
determining a modulation and coding scheme corresponding to a time and frequency resource group comprising a time and frequency resource for transmitting the preamble in the uplink data transmission as the modulation and coding scheme of uplink data according to the preamble in the uplink data transmission, and a correspondence relationship between time and frequency resource groups and modulation and coding schemes; or
selecting a modulation and coding scheme in a modulation and coding scheme group corresponding to a time and frequency resource group comprising a time and frequency resource for transmitting the preamble in the uplink data transmission as the modulation and coding scheme of uplink data according to the time and frequency resource for transmitting the preamble, and a correspondence relationship between time and frequency resource groups and modulation and coding scheme groups, wherein each modulation and coding scheme group comprises at least two modulation and coding schemes.

7. The method according to claim 2, wherein when the resources are preambles, and time and frequency resources for transmitting preambles, the determining the modulation and coding scheme of uplink data comprises:
determining a modulation and coding scheme corresponding to the preamble in the uplink data transmission, and a time and frequency resource group comprising a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding schemes; or
selecting a modulation and coding scheme in a modulation and coding scheme group corresponding to the preamble in the uplink data transmission, and a time and frequency resource group comprising a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding scheme groups, wherein each modulation and coding scheme group comprises at least two modulation and coding schemes.

8. A data receiving method, comprising:
receiving encoded and modulated uplink data, and a preamble, transmitted by a UE, and determining a modulation and coding scheme of uplink data according to a protocol specification, and/or information broadcasted by a gNB (next-Generation Node B); and
decoding and demodulating the uplink data using the determined modulation and coding scheme.

9. The method according to claim 8, wherein the determining the modulation and coding scheme of uplink data according to the protocol specification, and/or the information broadcasted by the gNB comprises:
selecting one of at least one modulation and coding scheme specified in the protocol specification and/or broadcasted by the gNB as the modulation and coding scheme of uplink data; and/or
determining the modulation and coding scheme of uplink data according to a correspondence relationship between resources and modulation and coding schemes specified in the protocol specification and/or broadcasted by the gNB; wherein the resources comprises at least one of: preambles, and time and frequency resources for transmitting preambles.

10. (canceled)

11. (canceled)

12. The method according to claim 9, wherein when the resources are preambles, the determining the modulation and coding scheme of uplink data comprises:
determining a modulation and coding scheme corresponding to the preamble in the uplink data transmission as the modulation and coding scheme of uplink data according to a correspondence relationship between preambles and modulation and coding schemes; or
decoding and demodulating the uplink data using each of at least two modulation and coding schemes in a modulation and coding scheme group corresponding to the preamble in the uplink data transmission sequentially according to the preamble in the uplink data transmission, and a correspondence relationship between preambles and modulation and coding scheme groups, and determining a modulation and coding scheme with which the uplink data is decoded and demodulated successfully as the modulation and coding scheme of uplink data.

13. The method according to claim 9, wherein when the resources are time and frequency resources for transmitting preambles, the determining the modulation and coding scheme of uplink data comprises:
determining a modulation and coding scheme corresponding to a time and frequency resource group comprising a time and frequency resource for transmitting the preamble in the uplink data transmission as the modulation and coding scheme of uplink data according to the preamble in the uplink data transmission, and a correspondence relationship between time and frequency resource groups and modulation and coding schemes; or
decoding and demodulating the uplink data using each of at least two modulation and coding schemes in a modulation and coding scheme group corresponding to a time and frequency resource group comprising a time and frequency resource for transmitting the preamble in the uplink data transmission sequentially according to the time and frequency resource for transmitting the preamble in the uplink data transmission, and a correspondence relationship between time and frequency resource groups and modulation and coding scheme groups, and determining a modulation and coding scheme with which the uplink data is decoded and demodulated successfully as the modulation and coding scheme of uplink data.

14. The method according to claim 9, wherein when the resources are preambles, and time and frequency resources for transmitting preambles, the determining the modulation and coding scheme of uplink data comprises:
determining a modulation and coding scheme corresponding to the preamble in the uplink data transmission, and a time and frequency resource group comprising a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding schemes; or
decoding and demodulating the uplink data using each of at least two modulation and coding schemes in a modulation and coding scheme group corresponding to the preamble in the uplink data transmission, and a time and frequency resource group comprising a time and frequency resource for transmitting the preamble sequentially according to the preamble in the uplink data transmission, the time and frequency resource for transmitting the preamble in the uplink data transmission, and a correspondence relationship between preambles and time and frequency resource groups for transmitting the preambles, and modulation and coding scheme groups, and determining a modulation and coding scheme with which the uplink data is decoded and demodulated successfully as the modulation and coding scheme of uplink data.

15. A UE, comprising:
a processor configured to read and execute program in a memory:
to determine a modulation and coding scheme of uplink data for uplink data transmission of an initial access according to a protocol specification, and/or information broadcasted by a gNB (next-Generation Node B), and to encode and modulate the uplink data using the determined modulation and coding scheme; and
a transceiver configured to transmit and receive data under the control of the processor, and configured:
to transmit a preamble, and the encoded and modulated uplink data.

16. The UE according to claim 15, wherein the processor configured to determine the modulation and coding scheme of uplink data according to the protocol specification, and/or the information broadcasted by the gNB is configured:
to select one of at least one modulation and coding scheme specified in the protocol specification and/or broadcasted by the gNB as the modulation and coding scheme of uplink data; and/or
to determine the modulation and coding scheme of uplink data according to a correspondence relationship between resources and modulation and coding schemes specified in the protocol specification and/or broadcasted by the gNB; wherein the resources comprise at least one of: preambles, and time and frequency resources for transmitting preambles.

17. (canceled)

18. (canceled)

19. The UE according to claim 16, wherein when the resources are preambles, the processor configured to determine the modulation and coding scheme of uplink data is configured:
to determine a modulation and coding scheme corresponding to the preamble in the uplink data transmission as the modulation and coding scheme of uplink data according to a correspondence relationship between preambles and modulation and coding schemes; or
to select a modulation and coding scheme in a modulation and coding scheme group corresponding to the preamble in the uplink data transmission as the modulation and coding scheme of uplink data according to the preamble in the uplink data transmission, and a correspondence relationship between preambles and modulation and coding scheme groups, wherein each modulation and coding scheme group comprises at least two modulation and coding schemes.

20. The UE according to claim 16, wherein when the resources are time and frequency resources for transmitting preambles, the processor configured to determine the modulation and coding scheme of uplink data is configured:
to determine a modulation and coding scheme corresponding to a time and frequency resource group comprising a time and frequency resource for transmitting the preamble in the uplink data transmission as the modulation and coding scheme of uplink data according to the preamble in the uplink data transmission, and a correspondence relationship between time and frequency resource groups and modulation and coding schemes; or
to select a modulation and coding scheme in a modulation and coding scheme group corresponding to a time and frequency resource group comprising a time and frequency resource for transmitting the preamble in the uplink data transmission as the modulation and coding scheme of uplink data according to the time and frequency resource for transmitting the preamble, and a correspondence relationship between time and frequency resource groups and modulation and coding scheme groups, wherein each modulation and coding scheme group comprises at least two modulation and coding schemes.

21. The UE according to claim 16, wherein when the resources are preambles, and time and frequency resources for transmitting the preambles, the processor configured to determine the modulation and coding scheme of uplink data is configured:
to determine a modulation and coding scheme corresponding to the preamble in the uplink data transmission, and a time and frequency resource group comprising a time and frequency resource for transmitting the preamble as the modulation and coding scheme of uplink data according to the preamble in the uplink data transmission, the time and frequency resource for transmitting the preamble in the uplink data transmission, and a correspondence relationship between preambles, time and frequency resource groups for transmitting the preambles, and modulation and coding schemes; or
to select a modulation and coding scheme in a modulation and coding scheme group corresponding to the preamble in the uplink data transmission, and a time and frequency resource group comprising a time and frequency resource for transmitting the preamble as the modulation and coding scheme of uplink data according to the preamble in the uplink data transmission, the time and frequency resource for transmitting the preamble in the uplink data transmission, and a correspondence relationship between preambles, time and frequency resource groups for transmitting the preambles, and modulation and coding scheme groups, wherein each modulation and coding scheme group comprises at least two modulation and coding schemes.

22. A gNB (next-Generation Node B), comprising:
a transceiver configured to transmit and receive data under the control of a processor, and configured:
to receive encoded and modulated uplink data, and a preamble, transmitted by a UE; and
the processor configured to read and execute program in a memory:
to determine a modulation and coding scheme of uplink data according to a protocol specification, and/or information broadcasted by the gNB, and to decode and demodulate the uplink data using the determined modulation and coding scheme.

23. The gNB according to claim 22, wherein the processor configured to determine the modulation and coding scheme of uplink data according to the protocol specification, and/or the information broadcasted by the gNB is configured:
to select one of at least one modulation and coding scheme specified in the protocol specification and/or broadcasted by the gNB as the modulation and coding scheme of uplink data; and/or
to determine the modulation and coding scheme of uplink data according to a correspondence relationship between resources and modulation and coding schemes specified in the protocol specification and/or broadcasted by the gNB; wherein the resources comprise at least one of: preambles, and time and frequency resources for transmitting preambles.

24. (canceled)

25. (canceled)

26. The gNB according to claim 23, wherein when the resources are preambles, the processor configured to determine the modulation and coding scheme of uplink data is configured:
to determine a modulation and coding scheme corresponding to the preamble in the uplink data transmission as the modulation and coding scheme of uplink data according to a correspondence relationship between preambles and modulation and coding schemes; or
to decode and demodulate the uplink data using each of at least two modulation and coding schemes in a modulation and coding scheme group corresponding to the preamble in the uplink data transmission sequentially according to the preamble in the uplink data transmission, and a correspondence relationship between preambles and modulation and coding scheme groups, and to determine a modulation and coding scheme with which the uplink data is decoded and demodulated successfully as the modulation and coding scheme of uplink data.

27. The gNB according to claim 23, wherein when the resources are time and frequency resources for transmitting preambles, the processor configured to determine the modulation and coding scheme of uplink data is configured:
to determine a modulation and coding scheme corresponding to a time and frequency resource group comprising a time and frequency resource for transmitting the preamble in the uplink data transmission as the modulation and coding scheme of uplink data according to the preamble in the uplink data transmission, and a correspondence relationship between time and frequency resource groups and modulation and coding schemes; or
to decode and demodulate the uplink data using each of at least two modulation and coding schemes in a modulation and coding scheme group corresponding to a time and frequency resource group comprising a time and frequency resource for transmitting the preamble in the uplink data transmission sequentially according to the time and frequency resource for transmitting the preamble in the uplink data transmission, and a correspondence relationship between time and frequency resource groups and modulation and coding scheme groups, and to determine a modulation and coding scheme with which the uplink data is decoded and demodulated successfully as the modulation and coding scheme of uplink data.

28. The gNB according to claim 23, wherein when the resources are preambles, and time and frequency resources for transmitting the preambles, the processor configured to determine the modulation and coding scheme of uplink data is configured:
to determine a modulation and coding scheme corresponding to the preamble in the uplink data transmission, and a time and frequency resource group comprising a time and frequency resource for transmitting the preamble as the modulation and coding scheme of uplink data according to the preamble in the uplink data transmission, the time and frequency resource for transmitting the preamble in the uplink data transmission, and a correspondence relationship between preambles and time and frequency resource groups for transmitting the preambles, and modulation and coding schemes; or
to decode and demodulate the uplink data using each of at least two modulation and coding schemes in a modulation and coding scheme group corresponding to the preamble in the uplink data transmission, and a time and frequency resource group comprising a time and frequency resource for transmitting the preamble sequentially according to the preamble in the uplink data transmission, the time and frequency resource for transmitting the preamble in the uplink data transmission, and a correspondence relationship between preambles and time and frequency resource groups for transmitting the preambles, and modulation and coding scheme groups, and to determine a modulation and coding scheme with which the uplink data is decoded and demodulated successfully as the modulation and coding scheme of uplink data.

29-32. (canceled)
